(19) United States
(12) Patent Application Publication
(10) Pub. No.: US 2005/0149479 A1
(43) Pub. Date: Jul. 7, 2005

(54) Electronic message management system

(76) Inventors: P. Dean Richardson, Bothell, WA (US); Carlton G. Findley, Seattle, WA (US); Clifford M. Wright, Federal Way, WA (US); Steven R. Haynes, Issaquah, WA (US); Timothy J. Brown, Des Moines, WA (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/938,132

(22) Filed: Sep. 10, 2004

Related U.S. Application Data
(60) Provisional application No. 60/502,459, filed on Sep. 11, 2003.
(60) Provisional application No. 60/502,580, filed on Sep. 11, 2003.

(51) Int. Cl. G06F 7/00

(52) U.S. Cl. 707/1

(57) ABSTRACT

An electronic message management system, including in one embodiment, servers disposed at boundary points of an enterprise network, and employment of phrases of various message classifications, is disclosed and described herein.

### RELATED APPLICATIONS

The present application is a non-provisional application of provisional application Nos. 60/502,459 and 60/502,580, entitled “Email Filtering Methods and Apparatuses” and “Email Filter Management” respectively, both filed on Sep. 11, 2003. The present application claims priority to said non-provisional applications, and incorporates their specifications by reference, to the extent those specifications are consistent with the specification of this non-provisional application.

### FIELD OF THE INVENTION

The present invention relates generally, but not limited to, the fields of data processing and data communication. In particular, the present invention relates to the management and application of centralized policies to the delivery of electronic messages, including, for example, the mitigation of unwelcome or undesirable electronic messages, but also more broadly the control of offensive or private electronic messages.

### BACKGROUND OF THE INVENTION

With advances in computing and networking technology, electronic messaging, such as email, has become ubiquitous. It is used for personal as well as business communication. However, in recent years, the effectiveness of electronic messaging is undermined due to the rise and proliferation of spam mails and viruses.

Large enterprises, such as multi-national corporations, handle millions of electronic messages each day, employing multiple geographically dispersed servers, to serve their far flung constituent clients. The problem of unwelcome or undesirable electronic messages is especially difficult for them.

Large enterprises are often subject to significant legislation that specifies different types of message content that must be carefully controlled when either entering or leaving the enterprises. Such legislation may cover many types of information, including but not limited to financial information, personal information relating to the enterprise's employees or customers, and information of a sensitive nature regarding national security-related projects. The problem of protecting such information against inappropriate dissemination is especially difficult for them and has implications for electronic messaging.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of an electronic message management system, in accordance with some embodiments;

FIG. 2 illustrates the mail management server of FIG. 1 in further detail, in accordance with some embodiments;

FIG. 3 illustrates a boundary mail server of FIG. 1 in further detail, in accordance with some embodiments; and

FIG. 4 illustrates the operational flow between an external/internal mail sender and a boundary mail server, in accordance with some embodiments.

### DETAILED DESCRIPTION OF ILLUSTRATIVE EMBODIMENTS

Illustrative embodiments of the present invention include, but are not limited to, an electronic message management system, including a central mail management server, and a number of boundary mail servers.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising”, “having” and “including” are synonymous, unless the context dictates otherwise. The term “server” may be a hardware or a software implementation, unless the context clearly indicates one implementation over the other.

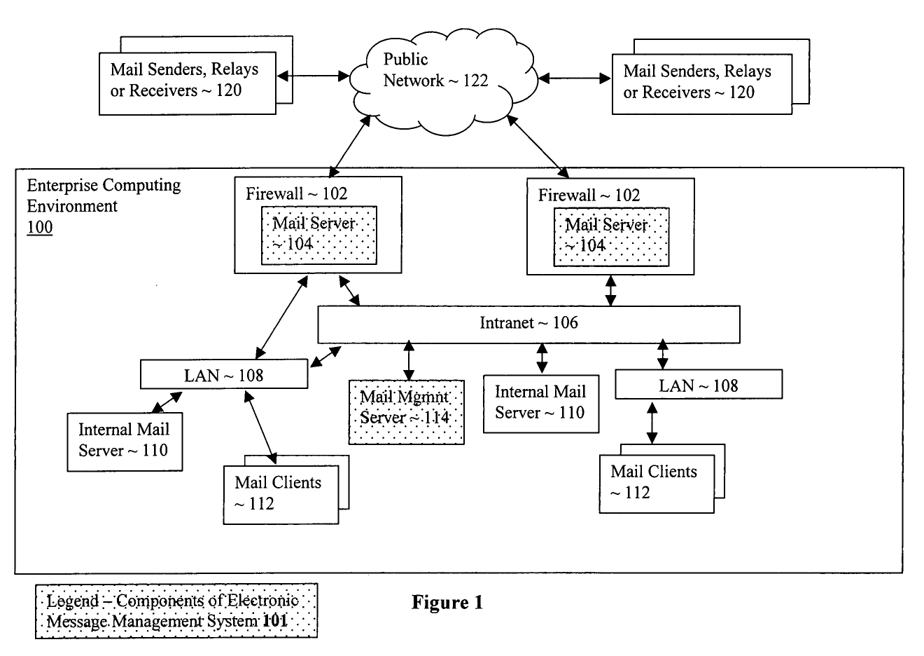

Referring now to FIG. 1, wherein an overview of an electronic message management system, in accordance with some embodiments, is shown. As will be apparent to those skilled in the art, the electronic message management system is particularly suitable for large enterprises, handling millions of electronic messages per day, utilizing numerous geographically dispersed servers. Since electronic mail is the most predominant form of electronic messages, for ease of understanding, the remaining descriptions will primary be presented in the context of electronic mail management. However, one skilled in the art will appreciate that the present invention may be practiced to manage all types of electronic messages, including but are not limited to electronic mails.

As illustrated, for the embodiments, electronic message management system 101 includes a central mail management server 114 and a number of distributed mail servers 104. For the embodiments, distributed mail servers 104 are placed on a number of devices, such as firewalls 102, located at a number of boundary points of enterprise computing environment 100. In alternate embodiments, the mail servers need not be placed on the same machine as the firewall. The firewall machines may sit on separate hardware from the mail servers, just in front of them and modulating access to them by servers outside the enterprise computing environment 100. The zone into which the perimeter mail servers are placed is usually called a “DMZ” (demilitarized zone), and is typically reserved for those few boundary servers (e.g. email, http, etc.) that need to provide network services that connect directly to external clients on the Internet (e.g. email senders, web browsers, etc.). Accordingly, distributed mail servers 104, whether it is placed directly on the same hardware with the firewall, or on separate hardware behind the firewall, in a DMZ, may also be referred to as boundary mail servers 104. Further, for the embodiments, boundary mail servers 104 are operatively coupled to central mail management server 114, through e.g. Intranet fabric 106. Intranet fabric 106 represents a collection of one or more networking devices, such as routers, switches and the like, to provide the operative coupling between boundary mail servers 104 and mail management server 114.

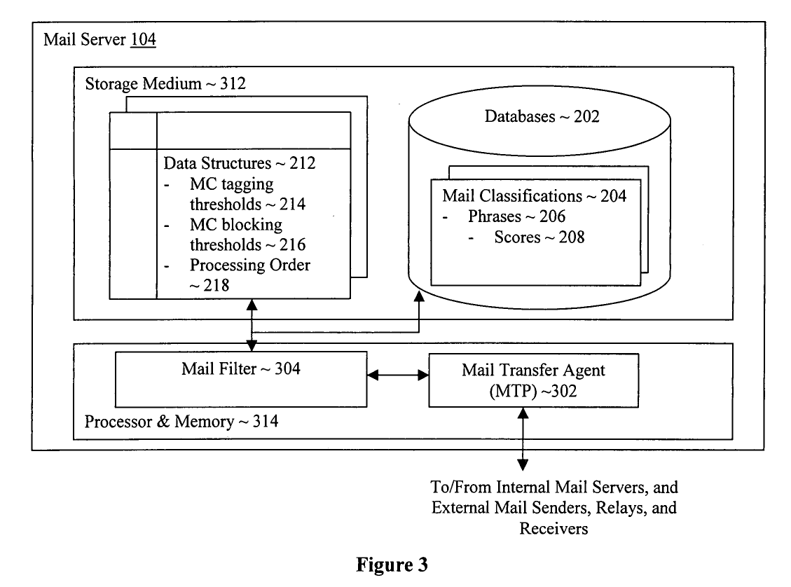

As will be described in more detail below, in various embodiments, boundary mail server 104 includes a mail transfer agent (MTA) component 302 and a mail filter component 304 (FIG. 3). In particular, MTA 302 is adapted to receive emails from electronic mail senders (which may be outside or within enterprise computing environment 100) using e.g. the Simple Mail Transfer Protocol (SMTP) and its extensions defined by the Internet Engineering Task Force (IETF) in [RFC2822] and related specifications, and mail filter component 304 is adapted to determine, and instruct MTA 302 on whether the received mails are to be accepted or rejected. Further, mail filter 304 is adapted to make the determination efficiently and consistently across enterprise computing environment 100, in accordance with the enterprise's email management policies. Still further, central mail management server 114 is employed to centrally manage the enterprise's electronic mail management policies. An example of a suitable MTA is Sendmail, available from Sendmail, Inc. of Emeryville, Calif., in particular, versions that support the Milter Application Programming Interface.

Continue to refer to FIG. 1, enterprise computing environment 100 is coupled to the external world, e.g. to various external mail senders, relays or receivers 120, through public network 122. External mail senders, relays or receivers 120 represent a broad range of these elements known in the art. Public network 122 may comprise one or more interconnected public networks, including but are not limited to the famous Internet.

Within enterprise computing environment 100, firewall 102 (including mail server 104 are coupled to other internal servers, such as the earlier described mail management server 114 and internal mail servers 110, and mail clients 112, through a number of internal networks, including but not limited to intranet 106 and local area networks 108.

In various embodiments, one of the internal servers, e.g. mail management server 114, may also be used as an analysis server, to facilitate analysis of various suspicious electronic mails by administrators of enterprise computing environment 100.

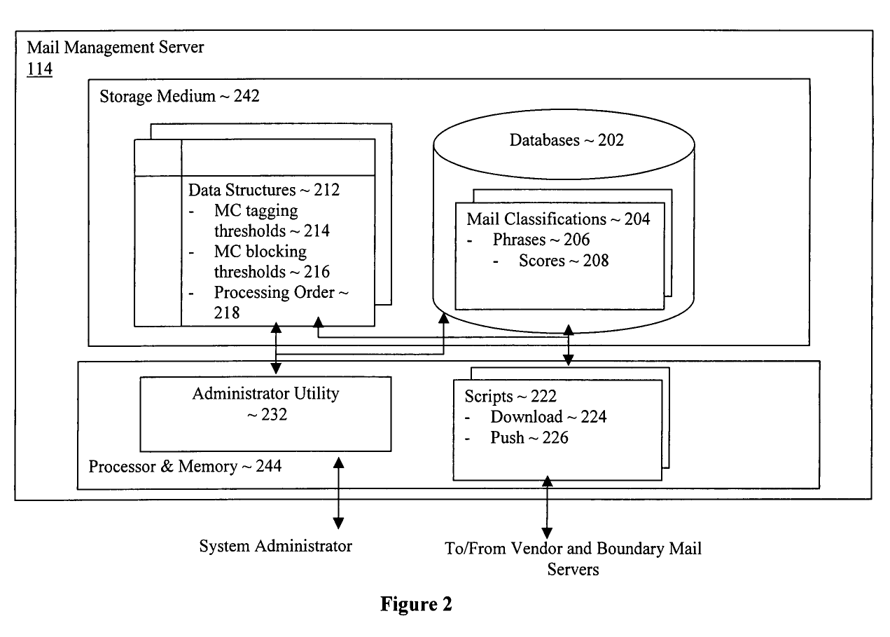

Referring now to FIG. 2, wherein mail management server 114 is illustrated in further detail, in accordance with various embodiments. As illustrated, for the embodiments, mail management server 114 includes one or more management databases 202 and one or more management data structures 212. For the embodiments, management databases 202 include a number of phrases 206, to be used to manage/filter electronic mails, for a number of mail classifications 204. Additionally, for the embodiments, stored with phrases 206 are corresponding scores 208 of the phrases 206. Scores 208 are employed to generate running scores for the various mail classifications 204, to enable determining whether an electronic mail should be considered a member of a mail classification 204. Accordingly, when a mail classification 204 is an unwelcome or undesirable mail classification, the electronic mail may be rejected.

In various embodiments, the corresponding score 208 of a phrase 206 is added to the running score of a mail classification 204, when presence of the phrase 206 is detected in an electronic mail. In various embodiments, to facilitate efficient operation, in determining whether a mail is to be considered as a member of a mail classification 204, the presence of a phrase 204 and its score 206 is counted only once, even if the phrase 204 is present in the mail more than once. Additionally, in various embodiments, a score 208 may be positive or negative. In various embodiments, a positive score value denotes that the presence of the phrase 206 indicates a mail is likely a member of the mail classification 204, whereas a negative score denotes that the presence of the phrase 206 indicates a mail is likely not a member of the mail classification 204.

In various embodiments, mail classifications 204 include the classifications of spam, porn, commercial, viruses, chain mails, attachments, and an administrator defined classification, such as a trusted parties message classification. Further, in various embodiments, a phrase may comprise one or more words, characters, and/or symbols of one or more languages. In various embodiments, a phrase may include a sender/recipient's electronic mailing address and/or network address.

Further, while for ease of understanding, embodiments of the present invention are being described with only unwelcome or undesirable mail classifications, in alternate embodiments, the present invention may be practiced with welcome or desirable mail classifications. For these embodiments, in lieu of blocking thresholds, acceptance thresholds may be provided for the mail classifications instead.

Still referring to FIG. 2, management data structures 212 include the corresponding tagging thresholds 214 and blocking thresholds 216 for the various mail classifications 204. A blocking threshold 216 denotes a score level, beyond which, a mail should be considered as a member of the unwelcome or undesirable mail classification 204, and be rejected accordingly. A tagging threshold 214 is score level, typically lower than the blocking threshold 216, denotes that beyond which, while the mail may not be definitively considered as a member of the unwelcome or undesirable mail classification 204, the mail should be considered strongly suspicious as a member of the unwelcome or undesirable mail classification 204, and may be subjected to further analysis, e.g. by an analyst or administrator. In various embodiments, management data structures 212 may also include disposition information, e.g. how tagging, re-routing, or duplicate routing is to be performed.

For the embodiments, mail management server 114 also includes a number of scripts 222 and an administrator utility 232 to facilitate loading and management of management databases 202 and management data structures 212. In particular, in various embodiments, scripts 222 include a script to download management databases 202 and management data structures 212 from a vendor/supplier, and administrator utility 232 includes features to allow an administrator to customize the downloaded management databases 202 and management data structures 212 to the liking of the enterprise.

Further, for the embodiments, scripts 222 include a script to push the most current version of management databases 202 and management data structures 212 onto boundary mail servers 104, allowing boundary mail servers 104 to operate more efficiently, without having to access management server 114 across the enterprise's internal network during operation. Such accesses may be time consuming, and significantly add to the network traffic on the internal network 106 of enterprise computing environment 100.

In alternate embodiments, in lieu of a script to “push” the current version of management databases 202 and management data structures 212 onto boundary mail servers 104, scripts adapted to “pull” the current version from mail management server 114 may be provided to the boundary mail servers 104 instead.

Additionally, for the embodiments, mail management server 114 includes one or more persistent storage units (storage medium) 242, employed to stored management databases 202 and management data structures 212. Further, mail management server 114 includes one or more processors and associated non-persistent storage (such as random access memory) 244, coupled to storage medium 242, to execute administrator utility 232 and scripts 222. For ease of reference, management databases 202 and management data structures 212 each or collectively may simply be referred to as “data structures”.

Referring now to FIG. 3, wherein a boundary mail server 104 is illustrated in further detail, in accordance to various embodiments. As alluded to earlier, mail server 104 includes a local copy of management databases 202 and management data structures 212. Further, for the embodiments, mail server 104 includes MTA 302 and mail filter 304. As described earlier, MTA 302 is adapted to send and receive electronic mails to and from other mail senders/receivers or relays 120/110 (internal or external to enterprise computing environment 100), and mail filter 304 is adapted to determine whether a received electronic mail is to be accepted or rejected.

For the embodiments, mail server 104 also includes one or more persistent storage units (or storage medium) 312, employed to stored management databases 202 and management data structures 212. Further, mail server 104 includes one or more processors and associated non-persistent storage (such as random access memory) 314, coupled to storage medium 312, to execute MTA 302 and mail filter 304.

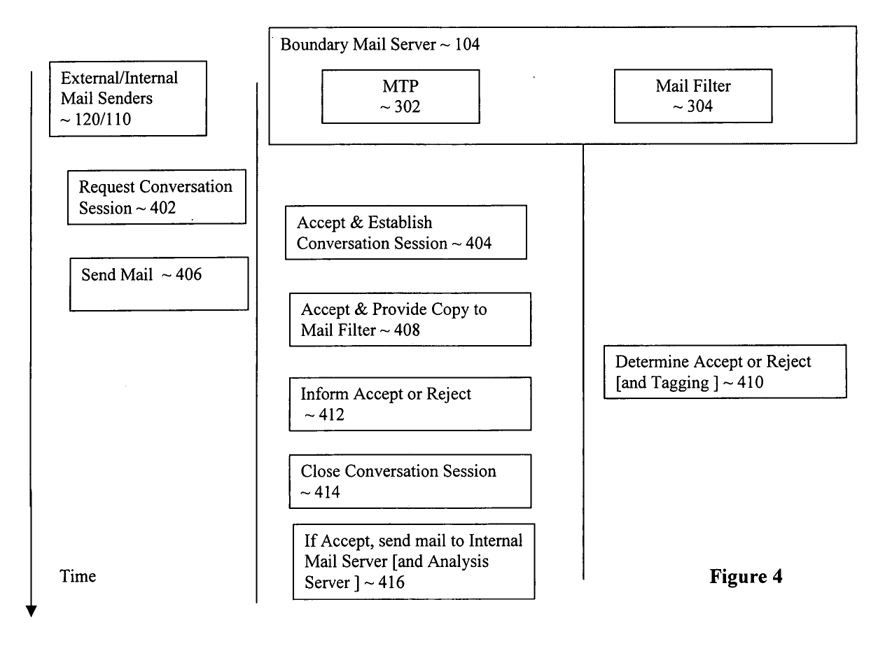

Referring now to FIG. 4, wherein the operational flow of an external/internal mail sender 120/110 and a boundary mail server 104, in accordance to various embodiments, is shown. As illustrated, for the embodiments, the operations start with mail sender 120/110 requesting MTA 302 of the boundary mail server 104 to establish a conversation session, op 402. In response, MTA 302 accepts and establishes the conversation session, op 404.

Next, mail sender 120/110 sends the electronic mail through the conversation session, op 406, and MTA 302 accepts the electronic mail, and provides a copy of the received electronic mail to mail filter 304, to determine whether the electronic mail is to be accepted or rejected, op 408.

In response, mail filter 304 makes the accept/reject determination, op 410. In various embodiments, as described earlier, mail filter 304 makes the accept/reject determination, using the local copy of the earlier described management databases 202 and management data structures 212. In particular, in various embodiments, mail filter 304 makes the determination by employing the phrases 206 of the various mail classifications 204, in accordance with the processing order 218 of the mail classifications.

In other words, in various embodiments, the phrases 206 of each mail classification 204, are employed successively, one mail classification at a time. In various embodiments, for each mail classification 204, the presence of each phase is determined, one at a time. As alluded to earlier, as soon as the presence of a phrase is detected, score 208 of the phrase 206 is added to a running score of the mail classification 204.

In various embodiments, the blocking threshold 216 of the mail classification 204 is examined, on addition of a phrase's score 208 to the running score of the mail classification 204. In various embodiments, the determination operation is stopped, as soon as the blocking threshold 216 of the mail classification 204 is exceeded. That is, as soon as the blocking threshold 216 of the mail classification 204 is exceeded, the electronic mail is identified as a member of the mail classification 204, and further analysis of phrases 206 of the mail classification 204, as well as phrases 206 of other lower processing order mail classifications 204, if any, are not examined. The approach may have the advantage of providing speedier determination.

Still referring to FIG. 4, if operation 410 proceeds to the end, processing all phrases 206 of all mail classifications 204, without exceeding any blocking thresholds 216 of any mail classifications 204, mail filter 304 further determines if any of the running scores generated for the mail classifications 204 nonetheless has exceeded the corresponding tagging thresholds 214 of the mail classifications 204. If so, mail filter 304 provides tagging information to MTA 302 to tag the electronic mail, when it accepts and forwards the electronic mail to the designated recipients.

Additionally, if analysis by an analyst or administrator is supported, mail filter 304 may further instruct MTA 302 to re-reroute or send an extra copy of the electronic mail to the analysis server (which may be the central management server 114).

Still referring to FIG. 4, based on the determination results returned, including instructions, if any, MTA 302 informs mail sender 120/110 whether the electronic mail is accepted or rejected, op 412. Thereafter, MTA 302 closes the conversation session, op 414. In other words, for the embodiments, the accept/reject determination is performed during the conversation session, prior to its termination. The approach may have the advantage of ensuring an unwelcome or undesirable mail sender is aware of the rejection, potentially causing the unwelcome or undesirable mail sender to remove the recipient(s) from its recipient list.

Thereafter, if the electronic mail is to be accepted, MTA 302 forwards the electronic mail to the appropriate internal mail server 110, op 416. Further, if instructed, MTA 302 further sends a copy of the electronic message to an analysis server, e.g. mail management server 114, op 416.

In various embodiments, the electronic mail is provided from mail sender 120/110 to MTA 302 in parts, in particular, first an identification of the sender, followed by identifications of the recipients, and then the body of the electronic mail, and MTA 302 invokes mail filter 304 to determine acceptance or rejection of the electronic mail for each part. In other words, the electronic mail may be rejected after receiving only the identification of the sender, or after receiving identifications of the recipients, without waiting for the entire electronic mail to be provided. Again, the approach may have the advantage of efficient operation.

Accordingly, the electronic message management system 101 is particular suitable for managing unwelcome or undesirable electronic messages for an enterprise computing environment 100. System 101 enables the enterprise to manage the policies for electronic message management from a central location, which in turn enables the enterprise to manage electronic message acceptance/rejection uniformly, even if their equipment is geographically dispersed. Further, system 101 enables unwelcome or undesirable electronic messages to be rejected outright, lessening wasteful network traffic on the internal network.

Note that while for ease of understanding, most of the descriptions are presented in the context of an electronic mail provided by an external mail senders 120, as alluded to a number of times, embodiments of the present invention may be practiced to manage outbound electronic mails from internal mail senders 110, to uniformly enforce enterprise policies on preventing unauthorized or undesirable electronic mails from being sent outside enterprise computing environment 100.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

1. An electronic message management system comprising:
storage medium, disposed inside an enterprise network; having stored therein one or more data structures having a plurality of phrases of a plurality of message classifications, corresponding message tagging thresholds and message blocking thresholds of the message classifications, and a processing order of the message classifications; and
a plurality of servers, correspondingly disposed at a plurality of boundary locations of the enterprise network, and coupled to the storage medium, each of the servers including
a copy of the one or more data structures,
a first plurality of programming instructions adapted to enable the server to determine whether to accept or reject a received electronic message, based at least in part on the plurality of phrases of the plurality of message classifications, the message tagging and blocking thresholds of the message classifications, and the processing order of the message classifications, and
a second plurality programming instructions adapted to enable the server to accept a request of a message sender to establish a conversation session, receiving an electronic message from the message sender, through the conversation session, and cooperating with the first plurality of programming instructions to accept or reject the received electronic message, prior to terminating the conversation session.

2. The system of claim 1, wherein the first programming instructions are adapted to enable the server to perform the accepting/rejecting determining by
determining whether a first phrase of a first message classification is present in the electronic message; and
generating a first score for the first message classification, based at least in part on the present determining of the first phrase.

3. The system of claim 2, wherein the first programming instructions are further adapted to enable the server to perform the accepting/rejecting determining by
determining whether the first score exceeds the message blocking threshold of the first message classification; and
terminating the accepting/rejecting determining, if it is determined that the first score exceeds the message blocking threshold of the first message classification.

4. The system of claim 3, wherein the first programming instructions are further adapted to enable the server to determine whether the first score exceeds the message tagging threshold of the first message classification, when it is determined that the first score does not exceed the message blocking threshold of the first message classification.

5. The system of claim 3, wherein the first programming instructions are further adapted to enable the server to perform the accepting/rejecting determining by
determining whether a second phrase of a second message classification is present in the electronic message, when it is determined that the first score does not exceeds the message blocking threshold of the first message classification, the second message classification having a later processing order than the first message classification; and
generating a second score for the second message classification, based at least in part on the present determining of the second phrase.

6. The system of claim 5, wherein the first programming instructions are further adapted to enable the server to perform the accepting/rejecting determining by
determining whether the second score exceeds the message blocking threshold of the second message classification; and
terminating said accepting/rejecting determining, if it is determined by the server that the second score exceeds the message blocking threshold of the second message classification.

7. The system of claim 6, wherein the first programming instructions are further adapted to enable the server to determine whether the first score exceeds the message tagging threshold of the first message classification, or the second score exceeds the message tagging threshold of the second message classification, when it is determined that neither the first score exceeds the message blocking threshold of the first message classification, nor the second score exceeds the message blocking threshold of the second message classification.

8. The system of claim 1, wherein the storage medium further comprises a third plurality of programming instructions adapted to enable the server to retrieve the one or more data structures, and periodic updates to the one or more data structures, from an external supplier source.

9. The system of claim 1, wherein the storage medium further comprises a third plurality of programming instructions adapted to enable the server to facilitate an administrator in customizing the one or more data structures.

10. The system of claim 1, wherein the storage medium further comprises a third plurality of programming instructions adapted to enable the server to provide the servers with their respective copies of the one or more data structures.

11. The system of claim 1, wherein each of the server further comprises a third plurality of programming instructions adapted to enable the server to obtain its local copies of the one or more data structures.

12. The system of claim 1, wherein the electronic message comprises an electronic mail.

13. A method, to be performed on a server, comprising:
receiving by the server, a plurality of phrases and their corresponding scores, for a plurality of message classifications;
receiving by the server, corresponding message tagging thresholds and message blocking thresholds for the message classifications;
receiving by the server, a processing order of the message classifications;
receiving by the server, an electronic message;
determining by the server, whether to accept or reject the received electronic message, including whether the electronic message is to be tagged, if the electronic message is to be accepted, based at least in part on the received phrases, their scores, the tagging and blocking thresholds, and the processing order of the message classifications; and
accepting or rejecting by the server, the electronic message based at least in part on the result of the determining.

14. The method of claim 13, wherein the accepting/rejecting determining by the server comprises
determining by the server, whether a first phrase of a first message classification is present in the electronic message; and
generating by the server, a first score for the first message classification, based at least in part on the present determining of the first phrase.

15. The method of claim 14, wherein
the accepting/rejecting determining by the server further comprises determining by the server, whether a second phrase of a first message classification is present in the electronic message; and
said first score generating by the server is further based on the present determining of the second phrase.

16. The method of claim 15, wherein the accepting/rejecting determining by the server further comprises
determining by the server, whether the first score exceeds the message blocking threshold of the first message classification; and
terminating by the server, said accepting/rejecting determining, if it is determined by the server that the first score exceeds the message blocking threshold of the first message classification.

17. The method of claim 16, wherein the method further comprises determining whether the first score exceeds the message tagging threshold of the first message classification, when it is determined that the first score does not exceed the message blocking threshold of the first message classification.

18. The method of claim 14, wherein the accepting/rejecting determining by the server further comprises
determining by the server, whether the first score exceeds the message blocking threshold of the first message classification; and
terminating by the server, said accepting/rejecting determining, if it is determined by the server that the first score exceeds the message blocking threshold of the first message classification.

19. The method of claim 18, wherein the method further comprises determining whether the first score exceeds the message tagging threshold of the first message classification, when it is determined that the first score does not exceed the message blocking threshold of the first message classification.

20. The method of claim 18, wherein the accepting/rejecting determining by the server further comprises
determining by the server, whether a second phrase of a second message classification is present in the electronic message, when it is determined that the first score does not exceeds the message blocking threshold of the first message classification, the second message classification having a later processing order than the first message classification; and
generating by the server, a second score for the second message classification, based at least in part on the present determining of the second phrase.

21. The method of claim 20, wherein the accepting/rejecting determining by the server further comprises
determining by the server, whether the second score exceeds the message blocking threshold of the second message classification; and
terminating by the server, said accepting/rejecting determining, if it is determined by the server that the second score exceeds the message blocking threshold of the second message classification.

22. The method of claim 21, wherein the method further comprises determining whether the first score exceeds the message tagging threshold of the first message classification, or the second score exceeds the message tagging threshold of the second message classification, when it is determined that neither the first score exceeds the message blocking threshold of the first message classification, nor the second score exceeds the message blocking threshold of the second message classification.

23. A method, to be performed on a server, comprising:
accepting by the server, a request, from an electronic message sender, to establish a conversation session;
receiving by the server, through the conversation session, an electronic message;
determining by the server, whether to accept or reject the received electronic message;
accepting or rejecting by the server, the electronic message, based at least in part on the result of the determining; and
terminating by the server, the conversation session with the electronic message sender, after said determining and accepting/rejecting.

24. The method of claim 23, wherein
the method further comprises receiving by the server, a plurality of phrases and their corresponding scores, for a plurality of message classifications; and
said determining is performed based at least in part on the received phrases and their scores.

25. The method of claim 24, wherein
the method further comprises receiving by the server, corresponding message tagging thresholds and message blocking thresholds for the message classifications; and
said determining is further performed based on the message tagging and blocking thresholds of the message classifications.

26. The method of claim 25, wherein
the method further comprises receiving by the server, a processing order of the message classifications; and
said determining is further performed based on the processing order of the message classifications.

27. The method of claim 23, wherein
the method further comprises receiving by the server, message tagging thresholds and message blocking thresholds for a plurality of message classifications; and
said determining is performed based on the message tagging and blocking thresholds of the message classifications.

28. The method of claim 27, wherein
the method further comprises receiving by the server, a processing order of the message classifications; and
said determining is further performed based on the processing order of the message classifications.

29. The method of claim 23, wherein
the method further comprises receiving by the server, a processing order of the message classifications; and
said determining is further performed based on the processing order of the message classifications.

30. An article of manufacture, comprising
a machine readable medium; and
a plurality of executable instructions designed to enable a server to perform a selected one of the methods of claim 8 and 23.

31. An apparatus comprising:
storage medium having stored therein
a first plurality of programming instructions adapted to determine whether to accept or reject a received electronic message, based at least in part on one or more of (a) a plurality of phrases of a plurality of message classifications, (b) message tagging thresholds of the message classifications, (c) message blocking thresholds of the message classifications, and (d) a processing order of the message classifications,
a second plurality programming instructions adapted to accept a request of a message sender to establish a conversation session, receiving an electronic message from the message sender, through the conversation session, and cooperating with the first plurality of programming instructions to accept or reject the received electronic message, prior to terminating the conversation session; and
a processor coupled to the storage medium to execute the first and second plurality of programming instructions.

32. The apparatus of claim 31, wherein the first programming instructions are adapted to enable the server to perform the accepting/rejecting determining by
determining whether a first phrase of a first message classification is present in the electronic message; and
generating a first score for the first message classification, based at least in part on the present determining of the first phrase.

33. The apparatus of claim 32, wherein the first programming instructions are further adapted to enable the server to perform the accepting/rejecting determining by
determining whether the first score exceeds the message blocking threshold of the first message classification; and
terminating the accepting/rejecting determining, if it is determined that the first score exceeds the message blocking threshold of the first message classification.

34. The apparatus of claim 33, wherein the first programming instructions are further adapted to enable the server to determine whether the first score exceeds the message tagging threshold of the first message classification, when it is determined that the first score does not exceed the message blocking threshold of the first message classification.

35. The apparatus of claim 33, wherein the first programming instructions are further adapted to enable the server to perform the accepting/rejecting determining by
determining whether a second phrase of a second message classification is present in the electronic message, when it is determined that the first score does not exceeds the message blocking threshold of the first message classification, the second message classification having a later processing order than the first message classification; and
generating a second score for the second message classification, based at least in part on the present determining of the second phrase.

36. The apparatus of claim 35, wherein the first programming instructions are further adapted to enable the server to perform the accepting/rejecting determining by
determining whether the second score exceeds the message blocking threshold of the second message classification; and
terminating said accepting/rejecting determining, if it is determined by the server that the second score exceeds the message blocking threshold of the second message classification.

37. The apparatus of claim 36, wherein the first programming instructions are further adapted to enable the server to determine whether the first score exceeds the message tagging threshold of the first message classification, or the second score exceeds the message tagging threshold of the second message classification, when it is determined that neither the first score exceeds the message blocking threshold of the first message classification, nor the second score exceeds the message blocking threshold of the second message classification.
